(19) United States
(12) Patent Application Publication
(10) Pub. No.: US 2014/0102319 A1
(43) Pub. Date: Apr. 17, 2014

(54) FILTER GROUP FOR DEEP FAT FRYER

(71) Applicant: Electrolux Professional S.p.A., Pordenone (IT)

(72) Inventors: Franco TASSAN-MANGINA, Marsure (IT); Marino FADELLI, Colle Umberto (IT); Maurizio SCACCO, Villotta di Chions (IT)

(21) Appl. No.: 14/048,403

(22) Filed: Oct. 8, 2013

(30) Foreign Application Priority Data
Oct. 12, 2012 (EP) 12188327.6

(51) Int. Cl. A47J 37/12

(52) U.S. Cl. CPC A47J 37/1223
USPC 99/408; 210/167.28

(57) ABSTRACT

A filter group (125, 325) for use in a deep fat fryer (100) is proposed. The filter group comprises a porous material filter envelope (240) for filtering cooking oil passing therethrough, and a spacer grid (245) adapted to be longitudinally fitted into the filter envelope for supporting it from inside, the filter envelope comprising an open end (250) for allowing fitting/unfitting of the spacer grid. The filter group further comprises an extraction pipe (255) for allowing extraction of filtered cooking oil from inside the filter envelope, said extraction pipe passing through a hole (270) of the filter envelope and being transversally connected to the spacer grid. In the solution according to one or more embodiments of the present invention, the extraction pipe is transversally connected to a peripheral portion of the spacer grid. The filter envelope comprises a longitudinal slit (265) extending between said open end and said hole for allowing the transversally-connected extraction pipe to be longitudinally guided therethrough while the spacer grid is being fitted into/unfitted from the filter envelope, whereby said fitting/unfitting of the spacer grid is allowed without disconnection of it from the extraction pipe.

### FIELD OF THE INVENTION

The present invention generally relates to kitchen appliances for deep fat frying of food, also known as deep fat fryers or deep fryers. More particularly, the present invention relates to an improved filter group for use in such deep fryers.

### BACKGROUND OF THE INVENTION

Modern deep fryers are commonly used in professional kitchens (e.g., in fast food restaurants) for performing deep fat frying of food—i.e., a cooking method wherein food is submerged in relatively large quantities of edible cooking oils at high temperature (e.g., 180° C. or higher).

A conventional deep fryer generally comprises a fry pot for containing cooking oil, as well as a—e.g., wire—basket for containing food. In operation, the basket is manually (or automatically) lowered into the fry pot (down to full submersion of food to be cooked into the cooking oil) and raised from it when cooking is finished (thereby allowing cooked food to be raised clear of the cooking oil).

As known, during the deep frying operations organic materials (e.g., food particles and other solid wastes) accumulate in the cooking oil, thus impairing life of the cooking oil and quality of the food cooked therein. In fact, overheated organic materials typically cause hydrolysis, oxidation, and polymerization processes that accelerate smoking and foaming of the cooking oil and decrease heat transfer efficiency thereof (thus involving uneven or almost no browning of the food).

For such reasons, the cooking oil should be kept free from organic materials. In order to achieve that, several different types of deep fryers exist in the prior art, all of them being substantially based on the common approach of draining the cooking oil (from the fry pot) into a pan, filtering it by means of a filter group arranged within the pan, and feeding the filtered cooking oil back to the fry pot for further cooking.

According to a widely practiced implementation, the filter group comprises a spacer grid, and a porous-material paper envelope containing it—hereinafter filter envelope. In such implementation, the filter envelope has front and back walls joined (e.g., sewed) at three of the four perimeter edges thereof, and is configured for fitting the spacer grid within it through the open end defined by the respective unsewed edges. Thus, upon said fitting, the spacer grid supports the filter envelope from inside (thereby keeping it uncollapsed). In this way, the interstices of the spacer grid identify, within the filter envelope, a free space (hereinafter, pocket) where filtered cooking oil (filtered as passing through the front and back walls of the filter envelope) is collected.

An extraction pipe, connected to the spacer grid through (a hole of the front or back wall of) the filter envelope, is provided for allowing extraction of filtered cooking oil from said pocket, whereas a sealing member is provided for sealing the open end, thus preventing unfiltered cooking oil within the pan from passing through it.

Broadly speaking, the fry pot is connected to the extraction pipe (and hence to the pocket) by means of a driven motor pump assembly. When the pump assembly is activated, the filtered cooking oil is extracted from the pocket and fed back to the fry pot for further cooking.

### SUMMARY OF THE INVENTION

The Applicant has found that the known and practiced deep fryers based on the above-described filter group are not fully satisfactory, especially due installation difficulties.

In fact, in order to ensure proper filtering of the cooking oil, maintenance (e.g., replacement) of the filter envelope should be carried out periodically by the user (or by the maintenance man).

However, extraction pipe disconnection from the spacer grid, extraction of the filter group from the deep fryer, and unsealing of the filter envelope open end operations are preliminarily required before carrying out filter envelope replacement, and opposite operations are backwardly required after it. Such operations, apart from involving time wasting, are unpractical, as the user has to handle a number of separated components (e.g., pipe, connectors, gaskets, as wells as the sealing member itself), thus making filter envelope replacement susceptible to many mistakes—for example, accidental loss or discard of some components, especially the smallest ones.

The Applicant has faced the problem of devising a satisfactory solution able to overcome the above-discussed drawbacks.

In particular, one or more aspects of the solution according to specific embodiments of the invention are set out in the independent claims, with advantageous features of the same solution that are indicated in the dependent claims (with any advantageous feature provided with reference to a specific aspect of the solution according to an embodiment of the invention that applies mutatis mutandis to any other aspect thereof).

An aspect of the solution according to one or more embodiments of the present invention relates to a filter group for use in a deep fat fryer. The filter group comprises a porous material filter envelope for filtering cooking oil passing therethrough, and a spacer grid adapted to be longitudinally fitted into the filter envelope for supporting it from inside, the filter envelope comprising an open end for allowing fitting/unfitting of the spacer grid. The filter group further comprises an extraction pipe for allowing extraction of filtered cooking oil from inside the filter envelope, said extraction pipe passing through a hole of the filter envelope and being transversally connected to the spacer grid. In the solution according to one or more embodiments of the present invention, the extraction pipe is transversally connected to a peripheral portion of the spacer grid. The filter envelope comprises a longitudinal slit extending between said open end and said hole for allowing the transversally-connected extraction pipe to be longitudinally guided therethrough while the spacer grid is being fitted into/unfitted from the filter envelope, whereby said fitting/unfitting of the spacer grid is allowed without disconnection of it from the extraction pipe.

Preferably, although not necessarily, the extraction pipe is transversally connected to the spacer grid by welding.

According to an embodiment of the present invention, the extraction pipe comprises an enlarged flange adapted to be connected to the peripheral portion of the spacer grid.

Advantageously, the filter group further comprises a sealing member for sealing said open end of the filter envelope. For example, the sealing member is coupled with the extraction pipe such as to be movable with respect to it.

According to an embodiment of the present invention, the filter envelope has a length greater than the length of the spacer grid, thus, upon said spacer grid fitting, the filter envelope comprises, at the open end side, an unsupported end portion not supported by the spacer grid.

Advantageously, the sealing member is configured to hold said unsupported end portion folded on at least part of the supported portion of the filter envelope.

For example, according to a preferred, not limiting embodiment, the sealing member comprises a C-shaped clip member having opposite first and second clip portions for clipping said folded unsupported end portion and said part of the supported portion therebetween.

Preferably, the C-shaped clip member is hinged onto the extraction pipe. For example, the extraction pipe rotatably and slidingly engages a through-hole in the first clip portion of the C-shaped clip member, thereby clipping/unclipping operations are achieved by a rotating and sliding movement of the clip member.

According to a different embodiment of the present invention, said sealing member is coupled with the extraction pipe so as to be tiltable between a lifted position, wherein said fitting/unfitting of the spacer grid is allowed, and a lowered position wherein it presses down said folded unsupported end portion on said part of the supported portion of the filter envelope at least by action of its own weight.

The filter group may further comprise a spring member for spring-loading the sealing member, the spring-loaded sealing member being configured to press down said folded unsupported end portion also by action of the spring force.

Another aspect of the solution according to one or more embodiments of the present invention relates to a deep fat fryer comprising the filter group of above.

The filter group of the present invention features a filter envelope/extraction pipe/sealing member arrangement that makes strongly easier the periodical maintenance thereof. In fact, being the extraction pipe fixedly connected to the spacer grid and the filter envelope provided with a dedicated slit for its passage, disconnection/connection of the extraction pipe is not required any longer before/after unfitting/fitting operations of the spacer grid. Moreover, being both the extraction pipe and the sealing member hinged thereto joined to the spacer grid, risks of accidental components loss are considerably reduced.

### BRIEF DESCRIPTION OF THE DRAWINGS

Other features and advantages of the solution according to one or more embodiments of the invention will be best understood with reference to the following detailed description, given purely by way of a non-restrictive indication, to be read in conjunction with the accompanying drawings (wherein corresponding elements are denoted with equal or similar references, and their explanation is not repeated for the sake of exposition brevity). In this respect, it is expressly understood that the figures are not necessarily drawn to scale (with some details that may be exaggerated and/or simplified) and that, unless otherwise indicated, they are simply used to conceptually illustrate the described structures and procedures. In particular:

FIG. 1 schematically shows a cross sectional view of a deep fryer according to an embodiment of the present invention;

FIGS. 2A-2B show perspective views illustrating assembly phases of a filter group of the deep fryer according to an embodiment of the present invention, and

FIGS. 3A-3B show perspective views illustrating assembly phases of a filter group of the deep fryer according to another embodiment of the present invention.

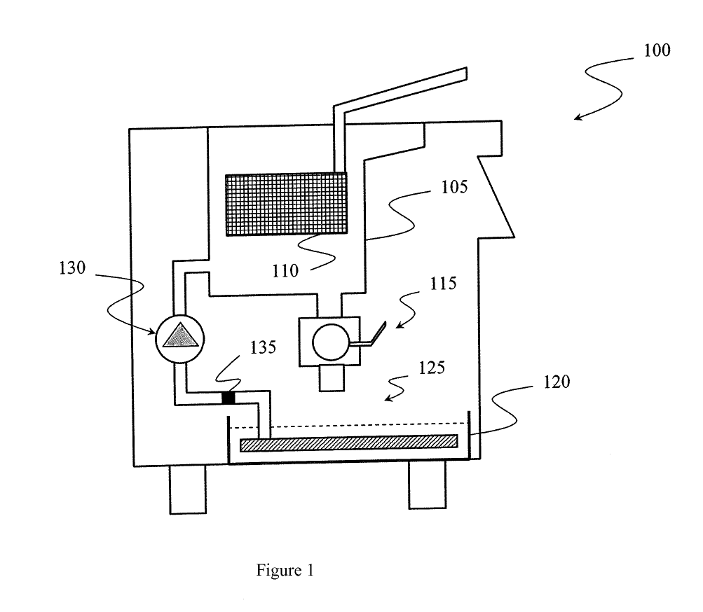

With reference to the drawings, FIG. 1 schematically shows a cross sectional view of a deep fryer 100 (e.g., of the domestic or professional type) according to an embodiment of the present invention.

The deep fryer 100 comprises a fry pot 105 for containing cooking oil (not shown), and a—e.g., wire—basket 110 for containing food to be cooked. As usual, the basket 110 is operable to be lowered into the fry pot 105 thereby allowing food cooking, and raised from it after its end.

As known, during deep frying operations organic materials accumulate in the cooking oil. Overheating of such organic materials may accelerate degradation of the cooking oil, thus impairing its life and quality of the food cooked therein (bad taste, dark color, unhealthy).

For such reasons, the deep fryer 100 is conceived such as to keep the cooking oil clean. In order to achieve that, the deep fryer 100 comprises a drainage valve 115, provided below (and fluidly connected with) the fry pot 105, for allowing, upon its opening, a certain (e.g., pre-set) amount of cooking oil to be fed by gravity down to a pan 120 (arranged at the bottom of the deep fryer 100), a filter group 125, housed within the pan 120, for filtering the cooking oil fed thereinto (as better described in the following), and a driven motor pump assembly 130, connected with the filter group 125 by means of a joint member 135, for feeding the filtered cooking oil back to the fry pot 105 for further cooking.

In order to ensure proper filtering of the cooking oil, maintenance or replacement of the filter group 125 should be carried out periodically by the user (or by the maintenance man).

In order to achieve that, the filter group 125 is disconnected from the joint member 135 (and hence, from the pump assembly 130), the pan 120 (together with the filter group 125 housed therein) is extracted from the deep fryer 100 by sliding movement, and the filter group 125 is taken away from the collection pan 120 for its maintenance/replacement, thereafter opposite operations are backwardly carried out for filter group 125 reinstallation.

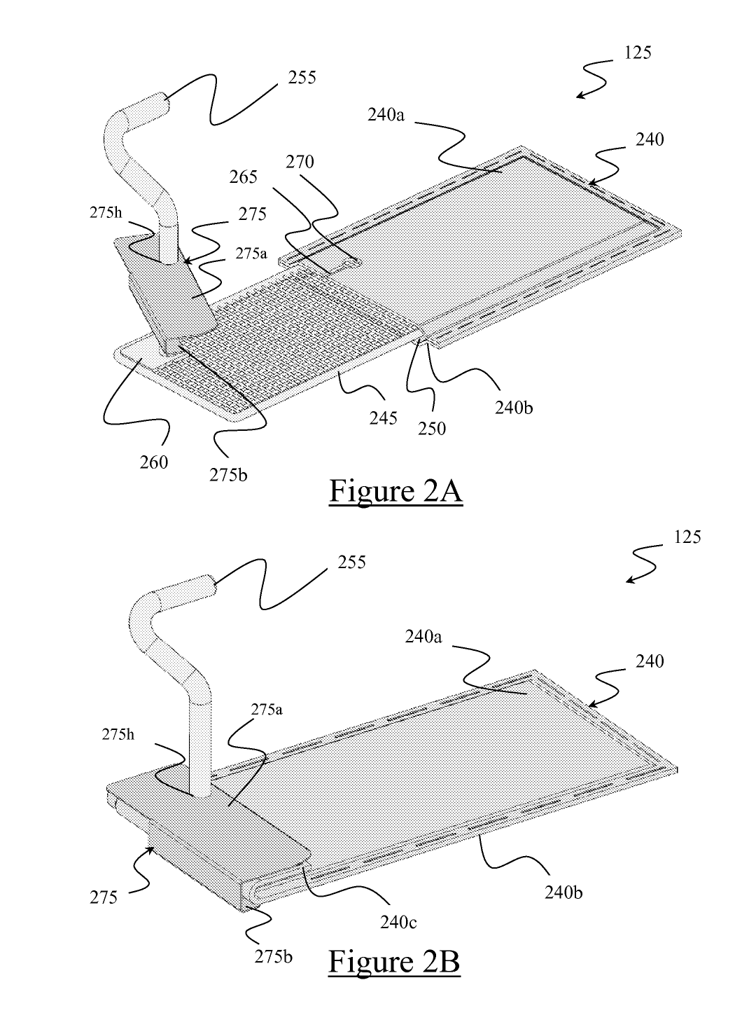

In the following, reference will be made also to FIGS. 2A-2B, which show perspective views illustrating the filter group 125 (at different assembly phases thereof) according to an embodiment of the present invention.

As best visible in FIG. 2A, the filter group 125 comprises a porous material filter envelope 240 for filtering cooking oil passing therethrough, and a spacer grid 245 adapted to be fitted into the filter envelope 240 for preventing it from collapsing.

In the disclosed embodiment, the filter envelope 240 has front 240a and back 240b walls joined (e.g., sewed) at three of the four perimeter edges thereof, and is configured to allow longitudinal fitting/unfitting of the spacer grid 245 through the open end 250 defined by the respective unsewed edges. Upon said fitting, the spacer grid 245 supports (at least part of) the filter envelope 240 from inside, thus defining an internal rigid frame for it. In this way, the interstices of the spacer grid 245 identify, within the filter envelope 240, a free space (hereinafter, pocket, not visible) where filtered cooking oil (i.e., the cooking oil resulting from passage through the front 240a and back 240b walls of the filter envelope 240) is collected.

The filter group 125 further comprises a (e.g., metal) extraction pipe 255 for piping, upon activation of the pump assembly 130, the filtered cooking oil extracted from the pocket of the filter envelope 240. In order to achieve that, an upper end of the extraction pipe 255 is adapted to be connected to the joint member 135 (as visible from FIG. 1). The opposite, lower end is instead mechanically connected to the spacer grid 245, and the extraction pipe 255 passes through a hole 270 of the filter envelope 240 (e.g., provided on the front wall 240a thereof), which hole 270 is advantageously shaped such as to tight enclose the extraction pipe 255 thereby preventing unwanted cooking oil flows therethrough.

In the exemplary disclosed embodiment, in order to ensure mechanical stability, the connection of the extraction pipe 255 to the spacer grid 245 is achieved by means of a connection plate 260. In the example at issue, the connection plate 260, preferably square-shaped, is monolithic with the extraction pipe 255, and identifies a flange of the lower end of the extraction pipe 255 suitable for achieving reliable and firm fixing.

As visible from FIG. 2A, the filter envelope 240 comprises a longitudinal slit 265, extending between the open end 250 and the hole 270, and configured to allow the transversally-connected extraction pipe 255 to be longitudinally moved/guided therethrough while the spacer grid 245 is being fitted into/unfitted from the filter envelope 240.

Advantageously, the extraction pipe 255 is connected at a peripheral portion of the spacer grid 245, and more advantageously—as herein illustrated—at a side peripheral portion (e.g., a corner) thereof. As a consequence, being the hole 270 arranged very close to the open end 250 of the filter envelope 240, the slit 265 can feature a very short length. Thus, the guiding of the extraction pipe 255 through the slit 265 can be brief and easy.

With respect to the known solutions, where the extraction pipe, arranged substantially centrally the spacer grid, must be disconnected for allowing fitting/unfitting operations, and reconnected after them (which is unpractical and involves excessive time wasting), the present invention allows said fitting/unfitting of the spacer grid 245 to be carried out while the extraction pipe 255 is guided (through the slit 265) into/from the hole 270. Thus, being the disconnection of the extraction pipe 255 not required any longer, the extraction pipe 255 (and/or the connection plate 260, if provided) can be more firmly connected to the spacer grid 245, for example by welding (incidentally, this improves reliability of the filter group 125, thereby preventing its breakage after relatively long periods of use, and after a relatively high number of uninstalling/installing cycles).

A sealing member 275 (or more than one sealing member) is provided for sealing the open end 250, thereby preventing unfiltered cooking oil within the pan 120 from passing through it (thus, bypassing the filtering action by the front 240a and back 240b walls of the filter envelope 240). In the disclosed embodiment, as visible in the FIG. 2B, the filter envelope 240 has a length greater than the length of the spacer grid 245, thereby upon spacer grid 245 fitting, an unsupported end portion 240c of the filter envelope 240 (i.e., not supported by the spacer grid 245), is folded up on (part of) the front 240a wall, and the sealing member 275 operated such as to seal such folded unsupported end portion 240c. In the example at issue, the filter envelope 240 is long enough to allow the folded unsupported end portion 240c to completely cover the slit 265, thereby preventing oil leakage therefrom.

According to the present invention, the sealing member 275 is hinged to the extraction pipe 255 such as to be movable along it and rotatable about it. In the FIGS. 2A-2B embodiment, the sealing member 275 is a C-shaped clip member having opposite upper 275a and lower 275b clip portions for clipping/holding the folded unsupported end portion 240c (and the spacer grid/filter envelope part below it) therebetween.

The upper clip portion 275a has a through-hole 275h adapted to hinge the extraction pipe 255 by rotatably/slidingly engaging it therethrough.

Preferably, as visible from the figures, the upper clip portion 275a is greater than the lower clip portion 275b. Even more preferably, the upper clip portion 275a is longer enough to allow arranging the through-hole 275h so that the extraction pipe 255 passing through it is not intercepted by the lower clip portion 275b, and wider enough to compress, upon said clipping, the folded unsupported end portion 240c onto the whole slit 265 (thereby ensuring optimal sealing thereof).

Thus, in (e.g., clipping) operation, after spacer grid 245 fitting and unsupported end portion 240c folding, the sealing member 275 is axially slid-down along the extraction pipe 255, thereafter it is rotated so as clip the folded unsupported end portion 240c—as should be readily understood, opposite operations are backwardly required for unclipping.

With respect to the known solutions, where the sealing member 275 is free/detached from the filter group, the present invention features a filter group 125 already integrating the sealing member 275, thus avoiding accidental loss thereof. Moreover, clipping/unclipping operations are extremely simple, as requiring only a few rotating and sliding movements.

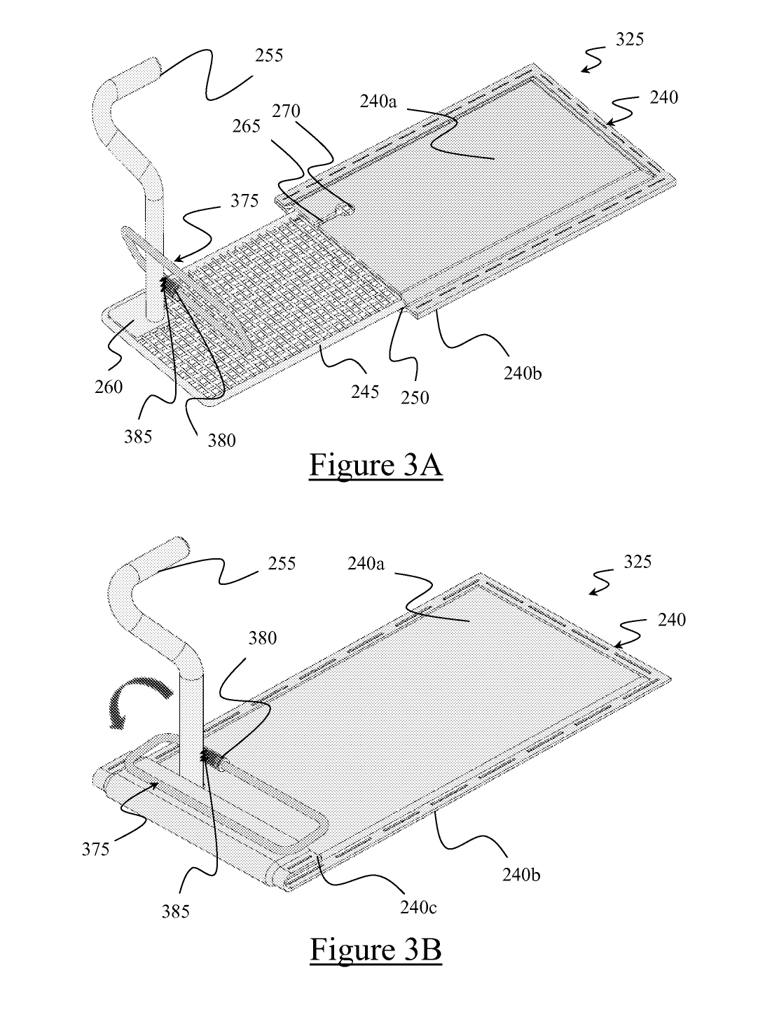

Turning now to FIGS. 3A-3B, they show perspective views illustrating assembly phases of a filter group 325 of the deep fryer 100 according to another embodiment of the present invention.

The filter group 325 differs from the filter group 125 for the provision of a sealing member 375 that, although conceptually analogous to the previous one, features a different implementation. As visible from the figures, the sealing member 375, preferably having an elongated-ring shape, comprises a hinging member 380 for hinging thereof to the extraction pipe 255, so that it can be tilted about a horizontal axis. Upon fitting the spacer grid 245 into the filter envelope 240, and folding-up the unsupported end portion 240c, the sealing member 375, previously tilted-up for allowing said fitting, is released, thereby the gravity force naturally acting on the sealing member 375 allows it to press down (and keep close) the folded unsupported end portion by its own weight. Preferably, as herein exemplary disclosed, such pressing action is assisted by a spring force (conceptually represented by the arrow illustrated in FIG. 3B) provided by a spring member 385, which spring-loads the sealing member 375 while the latter is tilted-up.

Naturally, in order to satisfy local and specific requirements, a person skilled in the art may apply to the solution described above many logical and/or physical modifications and alterations. More specifically, although the present invention has been described with a certain degree of particularity with reference to preferred embodiments thereof, it should be understood that various omissions, substitutions and changes in the form and details as well as other embodiments are possible. In particular, different embodiments of the invention may even be practiced without the specific details (such as the numeric examples) set forth in the preceding description for providing a more thorough understanding thereof; on the contrary, well known features may have been omitted or simplified in order not to obscure the description with unnecessary particulars. Moreover, it is expressly intended that specific elements and/or method steps described in connection with any disclosed embodiment of the invention may be incorporated in any other embodiment as a matter of general design choice.

1. Filter group (125, 325) for use in a deep fat fryer (100), the filter group comprising:
a porous material filter envelope (240) for filtering cooking oil passing therethrough,
a spacer grid (245) adapted to be longitudinally fitted into the filter envelope for supporting it from inside, the filter envelope comprising an open end (250) for allowing fitting/unfitting of the spacer grid, and
an extraction pipe (255) for allowing extraction of filtered cooking oil from inside the filter envelope, said extraction pipe passing through a hole (270) of the filter envelope and being transversally connected to the spacer grid,
characterized in that
the extraction pipe is transversally connected to a peripheral portion of the spacer grid, and in that the filter envelope comprises a longitudinal slit (265) extending between said open end and said hole for allowing the transversally-connected extraction pipe to be longitudinally guided therethrough while the spacer grid is being fitted into/unfitted from the filter envelope, whereby said fitting/unfitting of the spacer grid is allowed without disconnection of it from the extraction pipe.

2. The filter group according to claim 1, wherein the extraction pipe is transversally connected to the spacer grid by welding.

3. The filter group according to claim 1, wherein the extraction pipe comprises an enlarged flange (260) adapted to be connected to said peripheral portion of the spacer grid.

4. The filter group according to claim 1, further comprising a sealing member (275, 375) for sealing said open end of the filter envelope, the sealing member being coupled with the extraction pipe such as to be movable with respect to it.

5. The filter group according to claim 4, wherein the filter envelope has a length greater than the length of the spacer grid, thereby, upon said spacer grid fitting, the filter envelope comprises, at the open end side, an unsupported end portion (240c) not supported by the spacer grid, the sealing member being configured to hold said unsupported end portion folded on at least part of the supported portion of the filter envelope.

6. The filter group according to claim 5, wherein said sealing member comprises a C-shaped clip member (275) having opposite first (275a) and second (275b) clip portions for clipping said folded unsupported end portion and said part of the supported portion therebetween.

7. The filter group according to claim 6, wherein the C-shaped clip member is hinged onto the extraction pipe.

8. The filter group according to claim from 5, wherein the extraction pipe rotatably and slidingly engages a through-hole (275h) in the first clip portion of the C-shaped clip member, thereby clipping/unclipping operations are achieved by a rotating and sliding movement of the clip member.

9. The filter group according to claim 5, wherein said sealing member (375) is coupled with the extraction pipe so as to be tiltable between a lifted position, wherein said fitting/unfitting of the spacer grid is allowed, and a lowered position wherein it presses down said folded unsupported end portion on said part of the supported portion of the filter envelope at least by action of its own weight.

10. The filter group according to claim 9, further comprising a spring member (385) for spring-loading the sealing member, the spring-loaded sealing member being configured to press down said folded unsupported end portion also by action of the spring force.

11. Deep fat fryer comprising the filter group according to claim 1.
